(19) United States
(12) Patent Application Publication
(10) Pub. No.: US 2005/0068456 A1
(43) Pub. Date: Mar. 31, 2005

(54) Image pickup device and portable terminal

(75) Inventors: Tatsuo Ohta, Tokyo (JP); Satoshi Nakano, Tokyo (JP); Susumu Yamaguchi, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 10/936,351

(22) Filed: Sep. 8, 2004

(30) Foreign Application Priority Data
Sep. 25, 2003 (JP) 2003-333131

(51) Int. Cl. H04N 5/225

(52) U.S. Cl. 348/360

(57) ABSTRACT

An image pickup device includes: an image pickup lens; an image sensor mounted on a substrate; and a holding member having an infrared cut-off filter thereon, the infrared cut-off filter is formed by laminating a plurality of films in order to cut off an infrared wavelength range of an incident light, wherein the holding member is arranged between the image pickup lens and the image sensor.

### BACKGROUND OF THE INVENTION

1. Field of the Invention

The present invention relates to a small image pickup device in which an image sensor such as a CCD image sensor, a CMOS image sensor, and the like, is used, and a portable terminal using the image pickup device.

2. Description of Related Art

In the past, along with the popularization of a mobile phone, a personal computer and the like, various techniques have been proposed with respect to an image pickup device with an image sensor such as a CCD (Charge Coupled Device) image sensor, a CMOS (Complementary Metal Oxide Semiconductor) image sensor and the like.

An infrared cut-off filter for cutting off stray light within the infrared range is arranged in an optical system of an image pickup device disclosed in JP-Tokukaihei-5-207350A.

The infrared cut-off filter is configurated so as to be arranged, for example, adjacent to the incoming plane of the lens (first lens) closest to the object in an optical system or an image sensor, and fixed to a case of the image sensor or the lens itself.

However an infrared cut-off filter is different from an incorporated type of filter in which material for absorbing infrared light is mixed into glass or plastic material. The infrared cut-off filter is formed on a lens or the like as a laminated type of filter, for example, like an infrared cut-off filter comprising a multilayer film. Therefore the optical properties of the infrared cut-off filter change significantly depending on an incident angle of a beam. Thereby, in the case of an infrared cut-off filter arranged adjacent to the first lens as above compared with the case of the infrared cut-off filter arranged adjacent to an image sensor, there are a problem that the incident angle of a beam to the surface of the infrared cut-off filter becomes larger, and so the wavelength dependency of reflectance of infrared light shifts to a shorter wavelength than a designed wavelength; and another problem that the incident angle of an incoming beam to a periphery far from an optical axis becomes larger and so color shading is generated near the optical axis and in the periphery. Additionally, when the infrared cut-off filter is arranged adjacent to the first lens, there is a problem that a large infrared cut-off filter is necessary and leads to increasing the size of an image pickup device.

Furthermore mounting operation of an infrared cut-off filter is not easy because high accuracy of positioning is required for each lens constituting an optical system, which is a factor contributing to poor workability of production of an image pickup device.

### SUMMARY OF THE INVENTION

An object of the present invention is to provide an image pickup device that makes mounting operation of an infrared cut-off filter easy and can be miniaturized and upgraded, and a portable terminal using the image pickup device.

To solve the problem, in accordance with the first aspect of the present invention, an image pickup device of the present invention comprises:
an image pickup lens;
an image sensor mounted on a substrate; and
a holding member having an infrared cut-off filter thereon, the infrared cut-off filter is formed by laminating a plurality of films in order to cut off an infrared wavelength range of an incident light,
wherein the holding member is arranged between the image pickup lens and the image sensor.

According to an image pickup device of the present invention, the holding member in which the infrared cut-off filter is formed is arranged between the image pickup lens and the image sensor.

Consequently the distance between the infrared cut-off filter and the image sensor is shortened. Therefore, for example, compared with the case of the infrared cut-off filter arranged adjacent to the incoming plane of the image sensor, the incident angle of a beam to the surface of the infrared cut-off filter becomes smaller, and so, it is possible to prevent the wavelength dependency of the reflectance of infrared light from shifting to a shorter wavelength than a designed wavelength. Also it can be prevented that the incident angle of an incoming beam to a periphery far from an optical axis becomes larger and so color shading is generated near the optical axis and in the periphery.

Additionally, for example, the infrared cut-off filter can be miniaturized and the image pickup device can be miniaturized, compared with the case of the infrared cut-off filter arranged adjacent to the incoming plane of the first lens of the image sensor.

Also in the case of an infrared cut-off filter formed on the surface of an element such as a laminated type infrared cut-off filter, it is possible to provide an image pickup device capable of being miniaturized as the whole device without generation of degradation of optical properties such as shift of wavelength dependency and color shading.

Note that, in the present specification, “cut off an infrared wavelength range of an incident light” includes not only cases of cutting-off light in the wavelength range by reflecting the light in the wavelength range except light in other wavelength range selectively, but also cases of cutting-off the light in the wavelength range by absorbing the light in the wavelength range except light in other wavelength range.

In the case, preferably, the image pickup device further comprises an enclosing member in which the image pickup lens is housed between the enclosing member and the substrate.

Thereby, the refractive index and the thickness of a laminated layer can be adjusted by use of a laminated type infrared cut-off filter, the transmittance can be larger compared with an incorporated type cut-off filter, the half-power wavelength can be changed as desired. As a result, sharpness of an image is improved.

Also, preferably, the holding member is formed by resin.

Thereby the image pickup device can be used as a small image pickup device.

Also, preferably, a shape of the infrared cut-off filter is formed in a curved shape so that a convex side of the infrared cut-off filter faces toward the image sensor.

Thereby, an incident angle θᵢ (see FIG. 5) of a beam to the surface of the infrared cut-off filter can be decreased and the incident direction of the beam can be brought close to the normal of the curved surface by the infrared cut-off filter curved so that a convex side faces towards the image sensor, compared with cases of the infrared cut-off filter formed in a plane shape perpendicular to the optical axis. Therefore it is possible to prevent the wavelength dependency of the reflectance of infrared light from shifting to a shorter wavelength than a designed wavelength, and also it can be prevented that the incident angle of an incoming beam to a periphery far from an optical axis becomes larger and so color shading is generated near the optical axis and in the periphery.

It is possible to form a cut-off filter member of a complex shape suitable for the positioning of an image pickup device and miniaturization.

Also, preferably, a shape of the infrared cut-off filter is formed in a plane shape perpendicular to an optical axis.

Thereby, for example, the thickness of the infrared cut-off filter can be easily uniformed compared with cases of the infrared cut-off filter curved toward the image sensor.

Also, preferably, the holding member comprises an incoming plane side flange portion protruding from a surface on a luminous flux incoming plane side and an outgoing plane side flange portion protruding from a surface on a luminous flux outgoing plane side, both portions being provided out of an area in which the infrared cut-off filter is formed,
when the infrared cut-off filter is formed on the surface on the incoming plane side, θ1 denotes an angle made by a straight line joining an end of an outer peripheral side of infrared cut-off filter and an end of an inner peripheral side of the incoming plane side flange portion with an optical axis,
when the infrared cut-off filter is formed on the surface on the outgoing plane side, θ2 denotes an angle made by a straight line joining an end of an outer peripheral side of infrared cut-off filter and an end of an inner peripheral side of the outgoing plane side flange portion with the optical axis, and at least one of following formulas (1) and (2) is satisfied:
   θ1≧30° (1)
   θ2≧30° (2).

In forming an infrared cut-off filter, for example, by a vacuum evaporation method, a sputtering method, a CVD method or the like, θ1 and θ2 of less than 30° could lead to inadequate lamination because a portion of an effective face (area to be formed an infrared cut-off filter on) of the surface of the substrate is hidden behind each flange portion. Therefore an infrared cut-off filter can be formed within the effective face surely by adjusting the shape and the position for forming of each flange portion and the effective area in the design phase in advance.

In this case, preferably, the image pickup lens is brought into contact with the incoming plane side flange portion slidably.

As a result, workability of mounting operation of the infrared cut-off filter can be improved.

Additionally, it is possible to prevent the infrared cut-off filter from flaking away from the surface of the holding member when the image pickup lens slides because an infrared cut-off filter is not formed in the area in the surface of the holding member where the image pickup lens slides. As a result, it can be prevented that a part of the flaking infrared cut-off filter attaches to the surface of the image sensor or lens.

Also, preferably, sheet resistance of the infrared cut-off filter is not more than 10¹³ Ω/sq.

Thereby it can be prevented that a foreign body attaches to the surface of the infrared cut-off filter because of charging.

Also, preferably, the infrared cut-off filter is made an electrical conduction state.

Thereby it can be prevented that a foreign body attaches to the surface of the infrared cut-off filter because of charging.

In accordance with the second aspect of the present invention, a portable terminal of the present invention comprises the image pickup device of the first aspect.

According to a portable terminal of the present invention, the same effect as the first aspect can be obtained.

In accordance with the third aspect of the present invention, an image pickup device comprises:
an image pickup lens;
an image sensor mounted on a substrate; and
a holding member having an infrared cut-off filter to cut off an infrared wavelength range of an incident light thereon,
wherein the holding member is arranged at a predetermined distance from the image sensor and between the image pickup lens and the image sensor, and the image pickup lens is arranged in contact with the holding member so as to be positioned relative to the image sensor.

According to an image pickup device of the present invention, the image pickup lens is arranged in contact with the holding member so as to be positioned relative to the image sensor. Therefore workability of mounting operation of the infrared cut-off filter can be improved.

Additionally, the holding member is arranged at a predetermined distance from the image sensor and between the image pickup lens and the image sensor.

Consequently the distance between the infrared cut-off filter and the image sensor is shortened. Therefore, for example, compared with the case of the infrared cut-off filter arranged adjacent to the incoming plane of the image sensor, the incident angle of a beam to the surface of the infrared cut-off filter becomes smaller, and so, it is possible to prevent the wavelength dependency of the reflectance of infrared light from shifting to a shorter wavelength than a designed wavelength. Also it can be prevented that the incident angle of an incoming beam to a periphery far from an optical axis becomes larger and so color shading is generated near the optical axis and in the periphery.

Additionally, for example, the infrared cut-off filter can be miniaturized and so the image pickup device can be miniaturize, compared with the case of the infrared cut-off filter arranged adjacent to the incoming plane of the first lens of the image sensor.

Also in the case of an infrared cut-off filter formed on the surface of an element such as a laminated type infrared cut-off filter, it is possible to provide an image pickup device capable of being miniaturized as the whole device without generation of degradation of optical properties such as shift of wavelength dependency and color shading.

In the case, preferably, the image pickup device further comprises an enclosing member in which the image pickup lens is housed between the enclosing member and the substrate.

Thereby, the refractive index and the thickness of a laminated layer can be adjusted by use of a laminated type infrared cut-off filter, the transmittance can be larger compared with an incorporated type cut-off filter, the half-power wavelength can be changed as desired. As a result, sharpness of an image is improved.

Also, preferably, the holding member is formed by resin.

Thereby the image pickup device can be used as a small image pickup device.

Also, preferably, a shape of the infrared cut-off filter is formed in a curved shape so that a convex side of the infrared cut-off filter faces toward the image sensor.

Thereby, an incident angle θᵢ (see FIG. 5) of a beam to the surface of the infrared cut-off filter can be decreased and the incident direction of the beam can be brought close to the normal of the curved surface by the infrared cut-off filter curved so that a convex side faces towards the image sensor compared with cases of the infrared cut-off filter formed in a plane shape perpendicular to the optical axis. Therefore it is possible to prevent the wavelength dependency of the reflectance of infrared light from shifting to a shorter wavelength than a designed wavelength, and also it can be prevented that the incident angle of an incoming beam to a periphery far from an optical axis becomes larger and so color shading is generated near the optical axis and in the periphery.

It is possible to form a cut-off filter member of a complex shape suitable for the positioning of an image pickup device and miniaturization.

Also, preferably, a shape of the infrared cut-off filter is formed in a plane shape perpendicular to an optical axis.

Thereby, for example, the thickness of the infrared cut-off filter can be easily uniformed compared with cases of the infrared cut-off filter curved toward the image sensor.

Also, preferably, the holding member comprises an incoming plane side flange portion protruding from a surface on a luminous flux incoming plane side and an outgoing plane side flange portion protruding from a surface on a luminous flux outgoing plane side, both portions being provided out of an area in which the infrared cut-off filter is formed,
when the infrared cut-off filter is formed on the surface on the incoming plane side, θ1 denotes an angle made by a straight line joining an end of an outer peripheral side of infrared cut-off filter and an end of an inner peripheral side of the incoming plane side flange portion with an optical axis,
when the infrared cut-off filter is formed on the surface on the outgoing plane side, θ2 denotes an angle made by a straight line joining an end of an outer peripheral side of infrared cut-off filter and an end of an inner peripheral side of the outgoing plane side flange portion with the optical axis, and at least one of following formulas (1) and (2) is satisfied:
   θ1≧30° (1)
   θ2≧30° (2).

In forming an infrared cut-off filter, for example, by a vacuum evaporation method, a sputtering method, a CVD method or the like, θ1 and θ2 under 30° could lead to inadequate lamination because a portion of an effective face (area to be formed an infrared cut-off filter on) of the surface of the substrate is hidden behind each flange portion. Therefore an infrared cut-off filter can be formed within the effective face surely by adjusting the shape and the position for forming of each flange portion and the effective area in the design phase in advance.

In this case, preferably, the image pickup lens is brought into contact with the incoming plane side flange portion slidably.

As a result, workability of mounting operation of the infrared cut-off filter can be improved.

Additionally, it is possible to prevent the infrared cut-off filter from flaking away from the surface of the holding member when the image pickup lens slides because an infrared cut-off filter is not formed in the area in the surface of the holding member where the image pickup lens slides. As a result, it can be prevented that a part of the flaking infrared cut-off filter attaches to the surface of the image sensor or lens.

Also, preferably, sheet resistance of the infrared cut-off filter is not more than 10¹³ Ω/sq.

Thereby it can be prevented that a foreign body attaches to the surface of the infrared cut-off filter because of charging.

Also, preferably, the infrared cut-off filter is made an electrical conduction state.

Thereby it can be prevented that a foreign body attaches to the surface of the infrared cut-off filter because of charging.

In accordance with the fourth aspect of the present invention, a portable terminal of the present invention comprises the image pickup device of the third aspect.

According to a portable terminal of the present invention, the same effect as the third aspect can be obtained.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein:

FIG. 1 is an illustration showing an appearance of a mobile phone in which an image pickup device is incorporated;

FIG. 2 is a perspective view of the image pickup device;

FIG. 3 is a vertical section showing the inner structure of the image pickup device;

FIG. 4 is a perspective view of a holding member;

FIG. 5 is a vertical section of the holding member;

FIG. 6 is a vertical section of an inner structure of the image pickup device in an example;

FIG. 7 is a vertical section of a structure of an infrared cut-off filter;

FIG. 8 is a graph showing the relationship between transmittance and wavelength;

FIG. 9 is a vertical section showing an inner structure of the image pickup device in an example;

FIG. 10 is a vertical section showing an inner structure of the image pickup device in a comparative example; and

FIG. 11 is a vertical section showing an inner structure of the image pickup device in a comparative example.

### PREFERRED EMBODIMENTS OF THE INVENTION

Hereinbelow, a specific embodiment of the present invention is described but the present invention is not limited to showed examples.

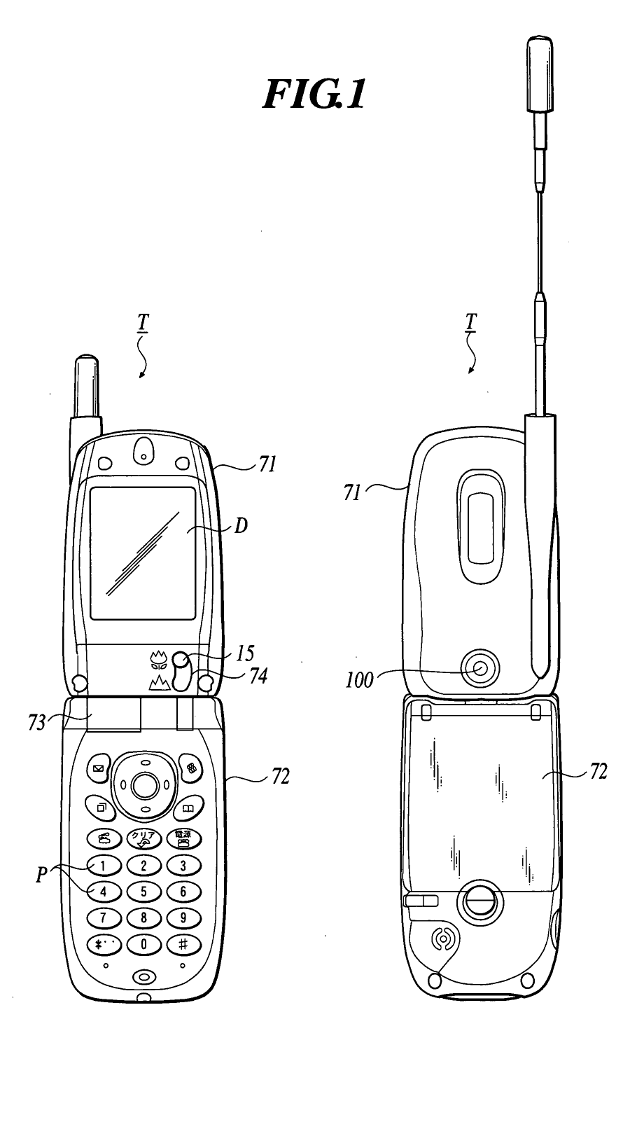

FIG. 1 is an illustration showing an appearance of a mobile phone T as an example of a portable terminal in which an image pickup device 100 of the present invention is incorporated.

In a mobile phone T, an upper package 71 as a case with a display screen D and a lower package 72 with manual operation buttons P are connected through a hinge 73. An image pickup device 100 is housed below the display screen D in the upper package 71, and arranged so as to take in light from the outer surface side of the upper package 71.

An arcuate opening 74 and a control member 15 are arranged below the display screen D of the upper package 71 so that the control member 15 is exposed from the opening 74. The focus distance is set for macro photography by moving the control member 15 upward in the figure in the opening 74.

The position of the image pickup device 100 may be arranged above or beside the display screen D in the upper package 71 and the same goes for the position of the control member 15. Of course, the mobile phone is not limited to a flip type.

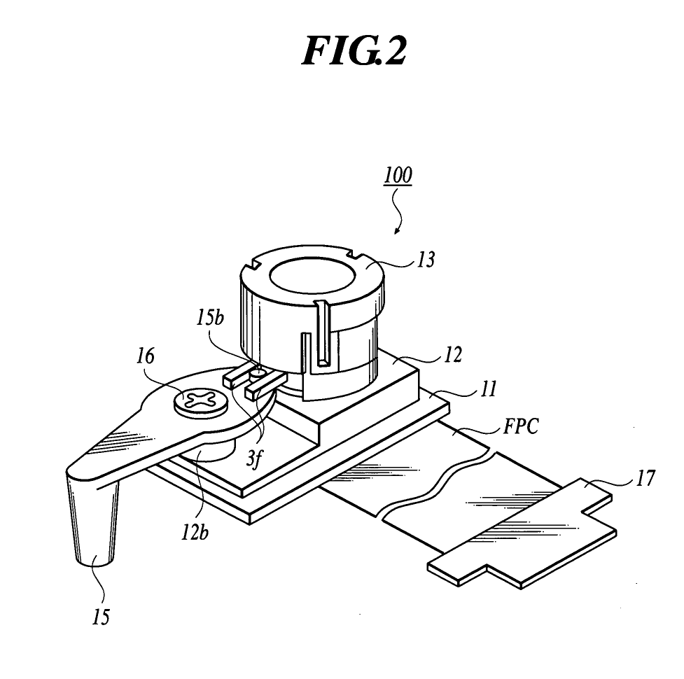

As shown in FIG. 2, the outer surface of the image pickup device 100 comprises a printed board 11 on which an image sensor 8 is mounted, a connector board 17 for connection to another control board, a flexible printed circuit FPC for connecting the printed board 11 and the connector board 17, an enclosing member 12, a cover member 13 built in the top face of the enclosing member 12, the control member 15 attached rotatably to a boss 12b formed integrally with the enclosing member 12, and a shoulder screw 16 for fixing the control member 15 rotatably.

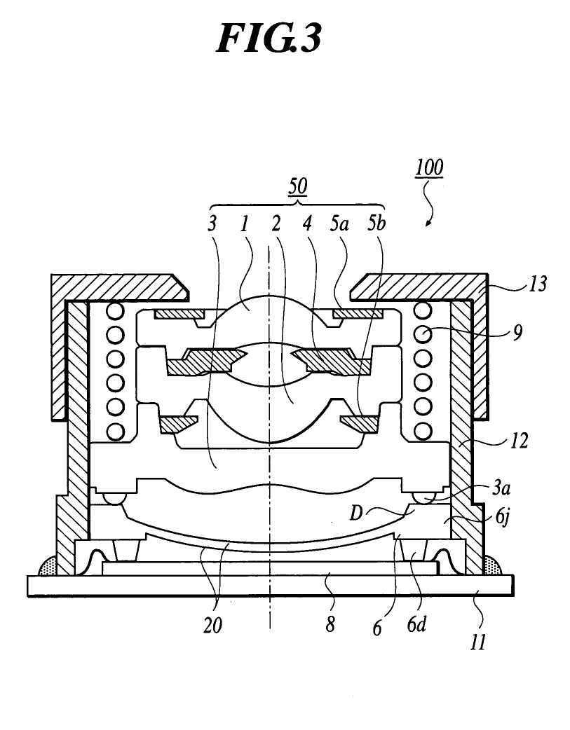

As shown in FIG. 3, the inside of the enclosing member 12 schematically comprises, from the side of an object: an image pickup optical system 50 comprising the first lens 1, the aperture diaphragm 4 for determining an aperture F value of the image pickup optical system 50, the second lens 2, fixed diaphragms 5a and 5b for intercepting unwanted light, and the third lens 3; a holding member 6 that has infrared cut-off filters 20 formed on its surfaces; an image sensor 8 mounted on the printed board 11; a compression coil spring 9 as an elastic member; and the cover member 13.

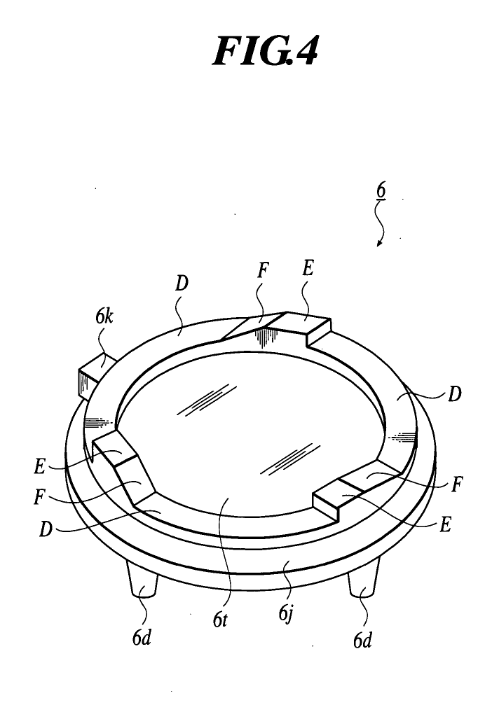

The holding member 6 is formed by material having translucency. As shown in FIG. 4, the lower portion of the holding member 6 comprises a circular peripheral part 6j with center at the optical axis.

On the surface of the holding member 6 facing toward the image pickup optical system 50 (the incoming plane side), a horizontal plane D (hereinafter, also referred to as an “incoming plane side flange portion”) with a low level, a horizontal plane E with a high level and an inclined plane F connecting the horizontal planes D and E continuously, are formed at each substantial 120° interval (hereinafter, a portion comprising the horizontal planes and the inclined planes F is referred to as a “cam plane”). On the surface of the holding member 6 facing toward the image surface (outgoing plane side), legs 6d (hereinafter, referred to as an “outgoing plane side flange portion”) are formed at least at 3 points.

An image-pickup luminous flux transmitting portion 6t that is curved a little toward the image sensor 8 is formed in the circular area of the holding member 6 with center at the optical axis. The infrared cut-off filters 20 are formed on both sides of the incoming plane and the outgoing plane of the image-pickup luminous flux transmitting portion 6t so that the infrared cut-off filters 20 is a shape curved toward the image sensor 8.

On the surface of a substrate, the infrared cut-off filters 20 comprises a structure in which a thin film is laminated by using a vacuum evaporation method, a sputtering method, a spin coating method, a dip coating method, a CVD method, an atmospheric pressure plasma method or the like.

The substrate comprises, for example, plastic material, glass material or complex thereof. The plastic material specifically comprises a transparent material, such as acrylic resin, polycarbonate resin, polyolefin resin (ZEONEX resin produced by Nippon ZEON Corp. or the like), and cyclic olefin copolymer resin. As the glass material, a known optical glass is used.

The substrate is formed in a shape of lens and produced by injection molding of plastic material, glass molding, polishing, cutting and the like.

From high refractive index material, middle refractive index material and low refractive index material, any one may be used alone and also a state of mixture or compound of some kinds may be used as material of the thin film.

The high refractive index material includes cerium oxide, titanium oxide, tantalum oxide, zirconium oxide, hafnium oxide, tungstic oxide, chrome oxide, silicon nitride, oxygen-containing silicon nitride, carbon-containing silicon nitride and the like. The middle refractive index material includes aluminum oxide, yttrium oxide, lead fluoride, cerium fluoride and the like. The low refractive index material includes silicon oxide, magnesium fluoride, aluminum fluoride, cryolite and the like. The above materials are used not only alone but also sometimes by mixture with other material.

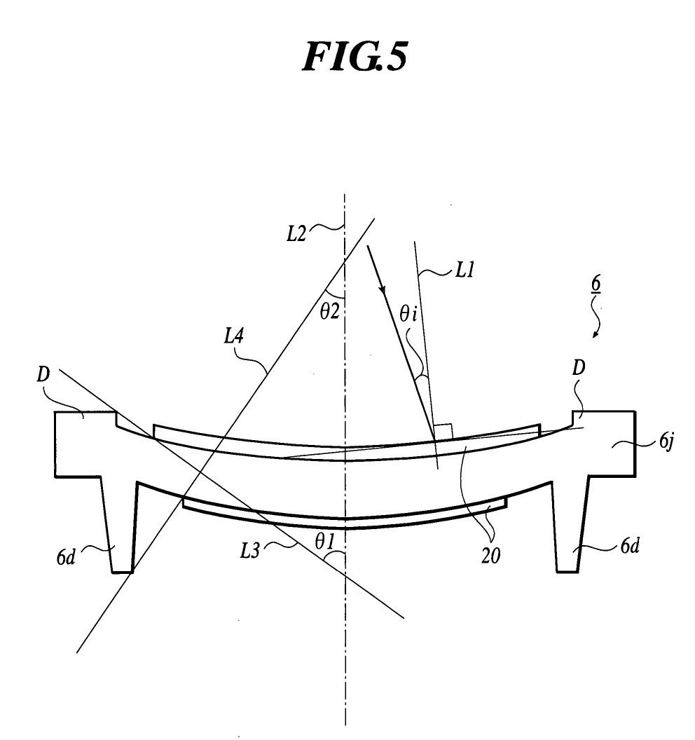

FIG. 5 is a vertical section showing details of the infrared cut-off filters 20. As described above, the infrared cut-off filters 20 are a shape curved toward the image sensor 8. By thus curving the infrared cut-off filters 20 towards the image sensor 8, an incident angle θᵢ (angle made by the normal and the beam) of a beam to the surface of the infrared cut-off filter 20 can be decreased and the incident direction of the beam can be brought close to the normal of the curved surface, compared with cases of the infrared cut-off filters 20 formed in a plane shape perpendicular to the optical axis. Therefore it is possible to prevent the wavelength dependency of the reflectance of infrared light from shifting to a shorter wavelength than a designed wavelength, and also it can be prevented that the incident angle of an incoming beam to a periphery far from an optical axis becomes larger and so color shading is generated near the optical axis and in the periphery.

In the image pickup device 100, an angle θ1 made by a straight line L3 joining an end of the outer peripheral side of the infrared cut-off filter 20 formed on the incoming plane side and an end of the inner peripheral side of the incoming plane side flange portion D with the optical axis L2, was made in the range of θ1≧30°. An angle θ2 (Formula 1) made by a straight line L4 joining an end of the outer peripheral side of the infrared cut-off filter 20 formed on the outgoing plane side and an end of the inner peripheral side of the outgoing plane side flange portion 6d with the optical axis L2, was made in the range of θ2≧30° (Formula 2).

As a reason of this, in forming the infrared cut-off filters 20, for example, by a vacuum evaporation method, a sputtering method, a CVD method or the like, θ1 and θ2 of less than 30° could lead to inadequate lamination because a portion of effective faces (area to be formed the infrared cut-off filters 20 on) of the surface of the substrate is hidden behind the incoming plane side flange portion D and outgoing plane side flange portion 6d when material of the thin films is caused to be absorbed onto the surface of the substrate. Therefore the infrared cut-off filter 20 can be formed within the effective face surely by adjusting the shape and the position for forming of each flange portion and the area of the effective face in the design phase in advance.

The “end of the outer peripheral side of the infrared cut-off filter 20” is not limited to the peripheral end itself, but may be a substantial peripheral portion of the infrared cut-off filter to be effective for incident light. That is, it is sufficient if the “end of the outer peripheral side of the infrared cut-off filter 20” is a peripheral portion corresponding to an effective diameter for incident light incoming to the surface of the substrate on which the infrared cut-off filter 20 is formed.

The holding member 6 has such a structure that the outgoing plane side flange portion 6d is attached to the image sensor 8 and the holding member 6 is fixed to the inner peripheral surface of the enclosing member 12 through the peripheral portion 6j.

The image pickup optical system 50 is unified by bringing the first lens 1, the second lens 2 and the third lens 3 in contact with each other at their flanges except optically effective portions, and by fixing them each other by an adhesive agent or the like. The image pickup optical system 50 is constructed without an error of mutual lens intervals by constituting through no other members.

Protrusions 3a are formed in intervals of substantial 120° with center at the optical axis on the image pickup plane side of the third lens 3, corresponding to the cam plane of the holding member 6. The third lens 3 is in contact with the cam plane of the holding member 6 at the protrusions 3a. Furthermore, on the object side of the flange portion of the third lens 3, the compression coil spring 9 is installed between the cover member 13 and the flange portion of the third lens 3. The image pickup optical system 50 and the holding member 6 is powered toward the image sensor 8 by the compression coil spring 9.

The boss 15b formed on the control member 15 made rotatably by the shoulder screw is constructed to be engaged with a bifurcated portion 3f of the third lens 3. A user of the image pickup device 100 controls the control member 15.

In the image pickup device 100 constructed as above, the bifurcated portion 3f of the third lens 3 engaged with the boss 15b is rotated by rotating operation of the control member 15, and then the protrusions 3a formed on the third lens 3 slides from the top face of the incoming plane side flange portion D through the inclined plane F to the high horizontal plane E. As a result, the image pickup optical system 50 moves toward an object along the optical axis. Therefore it is possible to switch long distance photography and short distance photography.

As above, because space in the photoelectric conversion side of the image sensor is sealed by the holding member 6, it is possible to solve a problem that dust intruding from the outside or generated by activation of the inside goes around and adheres onto the image sensor 8 to interfere with image data. Furthermore, a cam plane is formed on the holding member 6 that has the outgoing plane side flange portion 6d in contact with the image sensor 8 and the image pickup optical system 50 powered by the elastic member is brought into contact with the cam plane. Thereby the image pickup device 100 in which an intervenient member involved in the position in the direction of the optical axis can be limited to only the holding member 6, it is possible even to position accurately the image sensor 8 and the image pickup optical system 50 in the direction of the optical axis, and additionally, the close-up photography is possible, can be obtained.

Additionally the operation required for positioning the infrared cut-off filters 20 can be simplified and workability of production of the image pickup device 100 can be improved by forming the infrared cut-off filters 20 on the holding member 6.

Preferably the infrared cut-off filter 20 is not formed on the com plane to be slid on by the protrusions 3a of the third lens 3 by the rotating operation of the control member 15, in the surface of the holding member 6. As a result, it is possible to prevent the infrared cut-off filter from flaking by the protrusions 3a of the third lens 3 sliding and so it can be prevented that a part of the flaking infrared cut-off filter 20 attaches to the surface of the image sensor 8 or each lens.

For preventing a foreign body from attaching onto the surface of the infrared cut-off filters 20, preferably the sheet resistance of the infrared cut-off filters 20 is not more than 10¹³ Ω/sq or the surfaces of the infrared cut-off filters are made electrically conductive by providing wiring from the infrared cut-off filters 20 to a member except the holding member 6. For example, the sheet resistance can be made not more than 10¹³ Ω/sq by forming a transparent conductive film on the surface of the infrared cut-off filters 20. The transparent conductive film is known well as industrial material generally. The transparent conductive film is a film that hardly absorbs visible light (400 to 700 nm) and is transparent and additionally a good conductor. The film has characteristics that the transmission property of free charged object carrying electricity is high in the visible light range and the film is transparent and highly conductive.

The transparent conductive film includes a metallic oxide film, such as SnO₂, In₂O₃, CdO, ZnO₂, SnO₂:Sb, SnO₂:F, ZnO:Al and In₂O₃:Sn, and a composite oxide film by dopant. The composite oxide film by dopant includes, for example, an ITO film obtained by doping indium oxide with tin, an FTO film obtained by doping tin oxide with fluorine, an IZO film comprising In₂O₃—ZnO amorphous and the like.

As above, according to the image pickup device 100 shown in the present embodiment, the infrared cut-off filters 20 are formed on the surface of the holding member 6 that holds the image pickup lenses (the first lens 1, the second lens 2 and the third lens 3) in the state in which the lenses are positioned relative to the image sensor 8, and the holding member 6 is arranged between the image pickup lenses and the image sensor 8. Therefore, for example, because the incident angle θᵢ to the surface of the infrared cut-off filter 20 becomes smaller compared with the case of the infrared cut-off filter 20 arranged adjacent to the incoming plane of the first lens 1, it can be prevented that the wavelength dependency of reflectance of a beam shifts to a shorter wavelength than a designed wavelength, and also it can be prevented that the incident angle θᵢ of an incoming beam to a periphery far from an optical axis becomes larger and so color shading is generated near the optical axis and in the periphery. Additionally by making the infrared cut-off filters a shape curved toward the image sensor 8 and making the incident direction of a beam close to the normal L1 of the curved place, these effects can be reinforced much more. Also, for example, the infrared cut-off filters 20 can be miniaturized and the image pickup device 100 itself can be miniaturized compared with the case of the infrared cut-off filters arranged adjacent to the incoming plane of the first lens 1.

In the present embodiment, the infrared cut-off filters 20 are a shape curved toward the image sensor 8 but not limited thereto, and may be a plane shape perpendicular to the optical axis. The infrared cut-off filters 20 are formed on both surface on the incoming plane side and the outgoing plane side the holding member 6 but not limited thereto, and may formed only any one surface.

The shape of the holding member 6 is not limited to what is shown in FIG. 4, and for example, may be a structure in which the holding member 6 does not have a cum plane and the protrusions 3a of the third lens 3 are directly in contact with the surface on the incoming plane side of the holding member 6.

Although the image pickup optical system 50 comprises three image pickup lenses (the first to third lenses) in the present embodiment, the image pickup optical system 50 may comprise not more than 2 or not less than 4 lenses.

The image pickup device 100 of the present invention may be incorporated into not only the mobile phone T but also various things, such as a digital camera, a personal computer, a PDA, an audio-video equipment, a TV and a home appliance.

Next, an example 1 will be described.

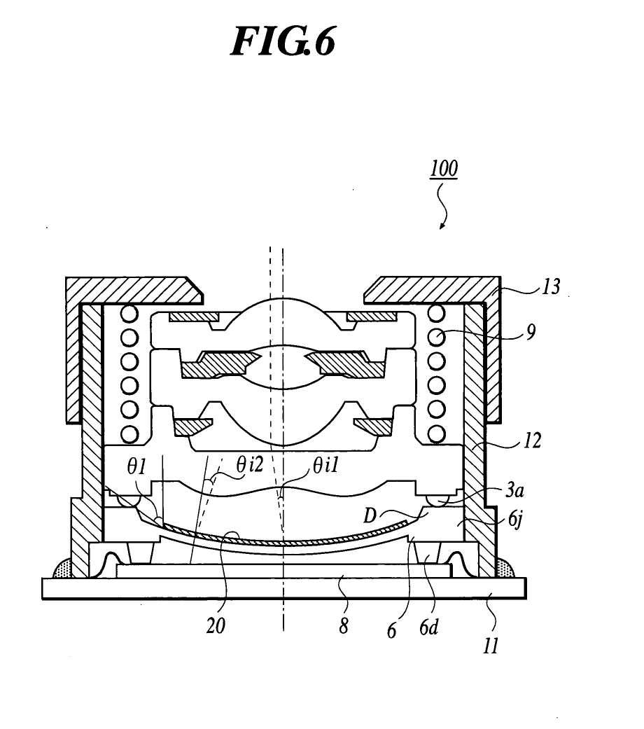

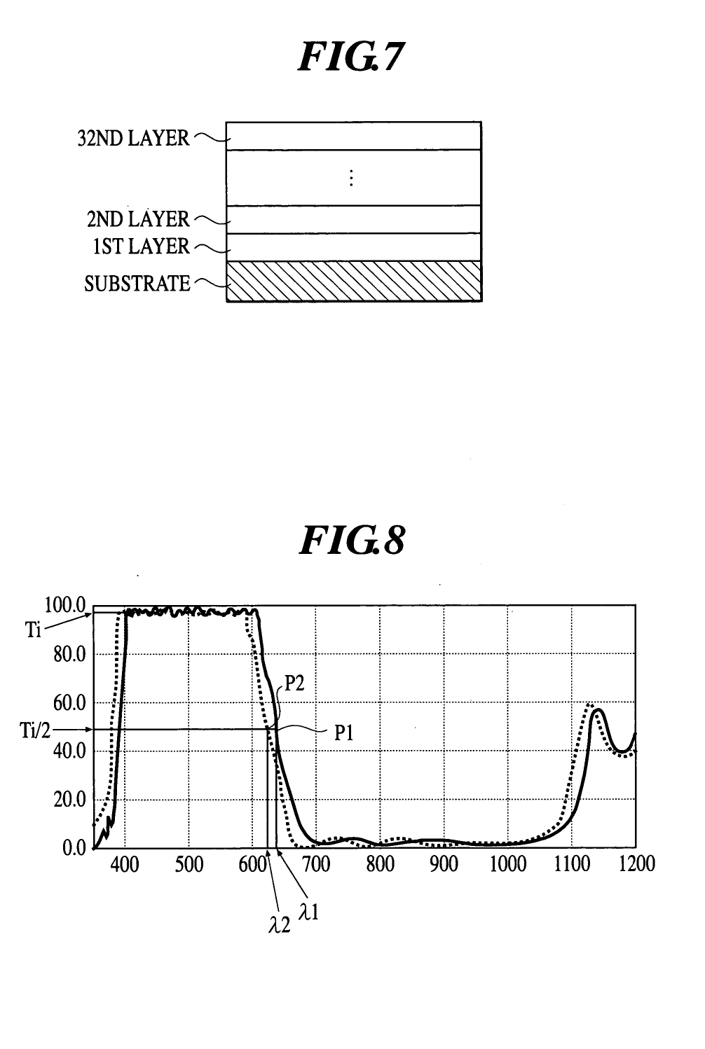

As shown in FIG. 6, in the present example, the image pickup device 100 is applied to an optical system of a digital camera and the infrared cut-off filter 20 of a layer structure shown in Table 1 and FIG. 7 is provided by a vacuum evaporation method on the incoming plane side of the holding member curved toward the image sensor 8.

TABLE 1
Layer structure
(the 1st layer is the closest to the substrate)

| | Material | Thickness (mm) |
|---|---|---|
| 1 | TiO₂ | 101.42 |
| 2 | SiO₂ | 130.73 |
| 3 | TiO₂ | 89.49 |
| 4 | SiO₂ | 120.73 |
| 5 | TiO₂ | 86.13 |
| 6 | SiO₂ | 115.09 |
| 7 | TiO₂ | 84.93 |
| 8 | SiO₂ | 121.57 |
| 9 | TiO₂ | 85.29 |
| 10 | SiO₂ | 125.68 |
| 11 | TiO₂ | 84.48 |
| 12 | SiO₂ | 124.4 |
| 13 | TiO₂ | 83.82 |
| 14 | SiO₂ | 126.11 |
| 15 | TiO₂ | 93.08 |
| 16 | SiO₂ | 157.34 |
| 17 | TiO₂ | 121.17 |
| 18 | SiO₂ | 156.48 |
| 19 | TiO₂ | 100.65 |
| 20 | SiO₂ | 146.59 |
| 21 | TiO₂ | 109.20 |
| 22 | SiO₂ | 159.16 |
| 23 | TiO₂ | 110.34 |
| 24 | SiO₂ | 154.60 |
| 25 | TiO₂ | 107.66 |
| 26 | SiO₂ | 153.69 |
| 27 | TiO₂ | 111.34 |
| 28 | SiO₂ | 159.52 |
| 29 | TiO₂ | 117.52 |
| 30 | SiO₂ | 156.54 |
| 31 | TiO₂ | 99.28 |
| 32 | SiO₂ | 70.94 |

Polycarbonate resin was used as a substrate of the holding member 6. For materials constituting the infrared cut-off filter 20, titanium oxide was used as the high refractive index material and silicon oxide was used as the low refractive index material.

The maximum beam incident angle θᵢ1 in the central portion of the effective face of the infrared cut-off filter 20 was 2° and the maximum beam incident angle θᵢ2 in the outermost peripheral portion was 10°. Here a beam incident angle is defined by the angle of an incoming beam with the normal of the incoming plane.

The half-power wavelength λ1 of the central portion (an incident angle of 0 to 2°) of the effective face of the infrared cut-off filter 20 was 630 to 629 nm and the half-power wavelength λ2 of the outmost peripheral portion (the maximum incident angle of 10°) was 625 nm. From here onwards, the difference of half-power wavelengths of the central portion and the outmost peripheral portion is 4 to 5 nm and is found to be significantly small.

A half-power wavelength is defined by a wavelength at which a transmittance is a half value T½ of the maximum transmittance T1 in the graph of FIG. 8. The vertical coordinate represents a transmittance (%) and the horizontal coordinate represents a wavelength (nm).

The wavelength λ1 of the central portion is shown by a wavelength at the position indicated by P1 in the graph, and the wavelength λ2 of the outmost peripheral portion is shown by a wavelength at the position indicated by P2.

The half-power wavelength λ2 of the incident angle of 10° was obtained by measuring the spectral transmittance in a beam incoming at an incident angle of 10° to the infrared cut-off filter 20 comprising the same material as the image pickup lenses which is formed on a plane plate comprising the same material.

The angle θ1 made by the straight line joining an end of the outer peripheral side of the infrared cut-off filter 20 and an end of the inner peripheral side of the incoming plane side flange portion D with an optical axis, was-made not more than 30°.

As a result, in the present example, it was possible to form the infrared cut-off filter 20 having uniform thickness in the effective face. No abnormality in color was found between in the central portion and in the outmost peripheral portion and a good image was obtained.

Next, an example 2 will be described.

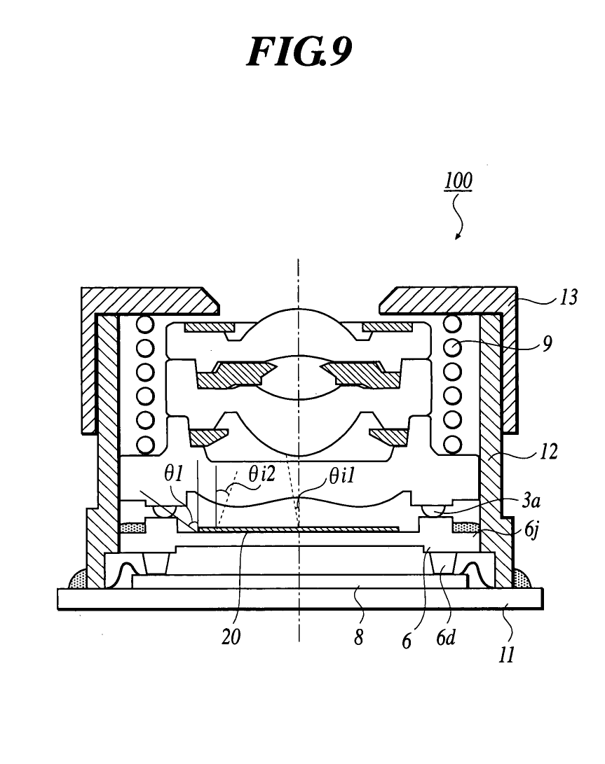

As shown in FIG. 9, in the present example, the image pickup device 100 is applied to an optical system of a digital camera and the infrared cut-off filter 20 of the same layer structure as the above-described example 1 is provided by a vacuum evaporation method on the incoming plane side of the holding member of a plane shape.

The maximum beam incident angle θᵢ1 in the central portion of the effective face of the infrared cut-off filter 20 was 2° and the maximum beam incident angle θᵢ2 in the outermost peripheral portion was 15°.

The half-power wavelength λ1 of the central portion (an incident angle of 0 to 2°) of the effective face of the infrared cut-off filter 20 was 630 to 629 nm and the half-power wavelength λ2 of the outmost peripheral portion (the maximum incident angle of 15°) was 622 nm. From here onwards, the difference of half-power wavelengths of the central portion and the outmost peripheral portion is 7 to 8 nm and is found to be significantly small.

The angle θ1 made by the straight line joining an end of the outer peripheral side of the infrared cut-off filter 20 and an end of the inner peripheral side of the incoming plane side flange portion D with an optical axis, was made not more than 30°.

As a result, in the present example, it was possible to form the infrared cut-off filter 20 having uniform thickness in the effective face. No abnormality in color was found between in the central portion and in the outmost peripheral portion and a good image was obtained.

Then, additionally, an indium oxide film with thickness of 5 nm was formed on the infrared cut-off filter 20 by a vacuum evaporation method. However its optical characteristics did not change in this case. The surface resistance (sheet resistance) could be suppressed not more than 100 kΩ/sq, and no foreign body was attached to the lens surface by static electricity in use for a long time. Degradation of an image was not caused.

Next, a comparative example 1 will be described.

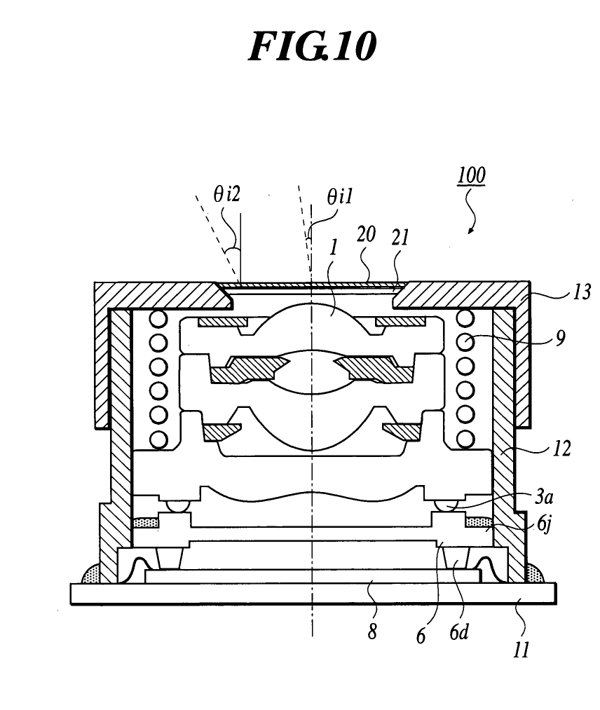

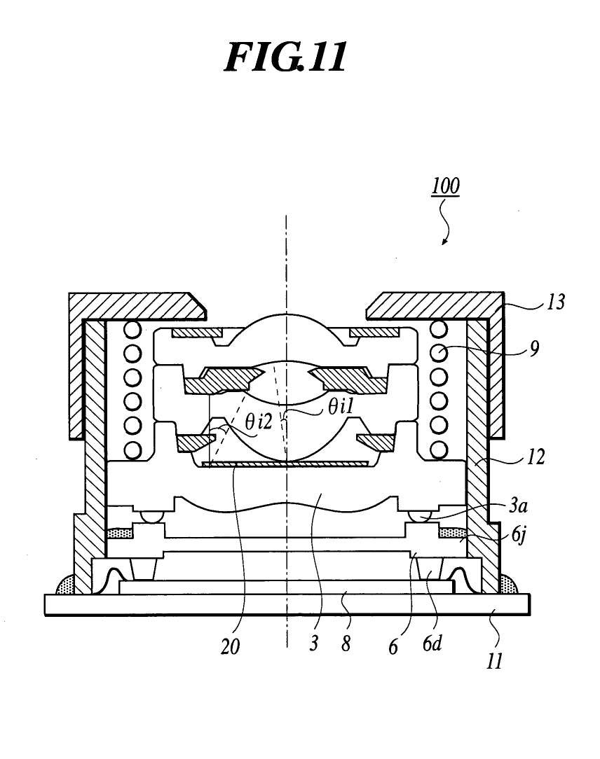

As shown in FIG. 10, in the present comparative example, the image pickup device 100 is applied to an optical system of a digital camera and the infrared cut-off filter 20 of the same layer structure as the example 1 is provided by a vacuum evaporation method on the surface of a glass substrate 21 with thickness of 0.5 mm that is provided in front of the object side of the first lens 1.

The maximum beam incident angle θᵢ1 in the central portion of the effective face of the infrared cut-off filter 20 was 2°. The maximum beam incident angle θᵢ2 in the outermost peripheral portion was 30°, which is 20° larger than the example 1 and 15° larger than the example 2.

The half-power wavelength λ1 of the central portion (an incident angle of 0 to 2°) of the effective face of the infrared cut-off filter 20 was 630 to 629 nm and the half-power wavelength λ2 of the outmost peripheral portion (the maximum incident angle of 30°) was 597 nm. From here onwards, the difference of half-power wavelengths of the central portion and the outmost peripheral portion is 32 to 33 nm and is found to be significantly large compared with the examples 1 and 2.

Consequently, difference of color to such an extent that there is a problem in practical use was found between in the central portion and in the outmost peripheral portion.

Next, a comparative example 2 will be described.

As shown in FIG. 11, in the present comparative example, the image pickup device 100 is applied to an optical system of a digital camera and the infrared cut-off filter 20 of the same layer structure as the example 1 is provided by a vacuum evaporation method on the plane on the object side of the third lens 3.

The maximum beam incident angle θᵢ1 in the central portion of the effective face of the infrared cut-off filter 20 was 2°. The maximum beam incident angle θᵢ2 in the outermost peripheral portion was 27°, which is 17° larger than the example 1 and 12° larger than the example 2.

The half-power wavelength λ1 of the central portion (an incident angle of 0 to 2°) of the effective face of the infrared cut-off filter 20 was 630 to 629 nm and the half-power wavelength λ2 of the outmost peripheral portion (the maximum incident angle of 27°) was 600 nm. From here onwards, the difference of half-power wavelengths of the central portion and the outmost peripheral portion is 29 to 30 nm and is found to be significantly large compared with the examples 1 and 2.

Consequently, difference of color to such an extent that there is a problem in practical use was found between in the central portion and in the outmost peripheral portion.

The entire disclosure of Japanese Patent Applications No. Tokugan 2003-333131 filed on Sep. 25, 2003 including specification, claims, drawings and summary are incorporated herein by reference in its entirety.

1. An image pickup device comprising:
an image pickup lens;
an image sensor mounted on a substrate; and
a holding member having an infrared cut-off filter thereon, the infrared cut-off filter is formed by laminating a plurality of films in order to cut off an infrared wavelength range of an incident light,
wherein the holding member is arranged between the image pickup lens and the image sensor.

2. The image pickup device of claim 1, further comprising an enclosing member in which the image pickup lens is housed between the enclosing member and the substrate.

3. The image pickup device of claim 1, wherein the holding member is formed by resin.

4. The image pickup device of claim 1, wherein the infrared cut-off filter is formed in a curved shape so that a convex side of the infrared cut-off filter faces toward the image sensor.

5. The image pickup device of claim 1, wherein the infrared cut-off filter is formed in a plane shape perpendicular to an optical axis.

6. The image pickup device of claim 1, wherein the holding member comprises an incoming plane side flange portion protruding from a surface on a luminous flux incoming plane side and an outgoing plane side flange portion protruding from a surface on a luminous flux outgoing plane side, the incoming plane side flange portion and the outgoing plane flange portion being provide out of an area in which the infrared cut-off filter is formed,
when the infrared cut-off filter is formed on the surface on the incoming plane side, θ1 denotes an angle made by a straight line joining an end of an outer peripheral side of infrared cut-off filter and an end of an inner peripheral side of the incoming plane side flange portion with an optical axis,
when the infrared cut-off filter is formed on the surface on the outgoing plane side, θ2 denotes an angle made by a straight line joining an end of an outer peripheral side of infrared cut-off filter and an end of an inner peripheral side of the outgoing plane side flange portion with the optical axis, and at least one of following formulas (1) and (2) is satisfied:
θ1≧30° (1)
θ2≧30° (2).

7. The image pickup device of claim 6, wherein the image pickup lens is brought into contact with the incoming plane side flange portion slidably.

8. The image pickup device of claim 1, wherein sheet resistance of the infrared cut-off filter is not more than 10¹³ Ω/sq.

9. The image pickup device of claim 1, wherein the infrared cut-off filter is made an electrical conduction state.

10. A portable terminal comprising the image pickup device of claim 1.

11. An image pickup device comprising:
an image pickup lens;
an image sensor mounted on a substrate; and
a holding member having an infrared cut-off filter to cut off an infrared wavelength range of an incident light thereon,
wherein the holding member is arranged at a predetermined distance from the image sensor and between the image pickup lens and the image sensor, and the image pickup lens is arranged in contact with the holding member so as to be positioned relative to the image sensor.

12. The image pickup device of claim 11, further comprising an enclosing member in which the image pickup lens is housed between the enclosing member and the substrate.

13. The image pickup device of claim 11, wherein the holding member is formed by resin.

14. The image pickup device of claim 11, wherein a shape of the infrared cut-off filter is formed in a curved shape so that a convex side of the infrared cut-off filter faces toward the image sensor.

15. The image pickup device of claim 11, wherein a shape of the infrared cut-off filter is formed in a plane shape perpendicular to an optical axis.

16. The image pickup device of claim 11, wherein the holding member comprises an incoming plane side flange portion protruding from a surface on a luminous flux incoming plane side and an outgoing plane side flange portion protruding from a surface on a luminous flux outgoing plane side, the incoming plane side flange portioin and the outgoing plane flange portion being provide out of an area in which the infrared cut-off filter is formed,
when the infrared cut-off filter is formed on the surface on the incoming plane side, θ1 denotes an angle made by a straight line joining an end of an outer peripheral side of infrared cut-off filter and an end of an inner peripheral side of the incoming plane side flange portion with an optical axis,
when the infrared cut-off filter is formed on the surface on the outgoing plane side, θ2 denotes an angle made by a straight line joining an end of an outer peripheral side of infrared cut-off filter and an end of an inner peripheral side of the outgoing plane side flange portion with the optical axis, and at least one of following formulas (1) and (2) is satisfied:
θ1≧30° (1)
θ2≧30° (2).

17. The image pickup device of claim 16, wherein the image pickup lens is brought into contact with the incoming plane side flange portion slidably.

18. The image pickup device of claim 11, wherein sheet resistance of the infrared cut-off filter is not more than 10¹³ Ω/sq.

19. The image pickup device of claim 11, wherein the infrared cut-off filter is made an electrical conduction state.

20. A portable terminal comprising the image pickup device of claim 11.
